(19) United States
(12) Patent Application Publication
(10) Pub. No.: US 2021/0165130 A1
(43) Pub. Date: Jun. 3, 2021

(54) PREDICTING SUN LIGHT IRRADIATION INTENSITY WITH NEURAL NETWORK OPERATIONS

(71) Applicant: SIEMENS AKTIENGESELLSCHAFT, MUENCHEN (DE)

(72) Inventors: TI-CHIUN CHANG, PRINCETON JUNCTION, NJ (US); PATRICK REEB, ADELSDORF (DE); JOACHIM BAMBERGER, STOCKDORF (DE)

(21) Appl. No.: 17/251,908

(22) PCT Filed: Jun. 14, 2018
(86) PCT No.: PCT/EP2018/065785

§ 371 Date: Dec. 14, 2020

(51) Int. Cl. G01W 1/10; G06K 9/46; G06K 9/00; G06T 7/11; G06T 7/20; G05B 13/02; G05B 13/04; G06N 3/04; G01J 1/44; H02J 3/38; H02J 3/00

(52) U.S. Cl. CPC G01W 1/10; G01J 2001/4285; G06K 9/0063; G06T 7/11; G06T 7/20; G06K 9/4652; G05B 13/027; G05B 13/048; G06N 3/0445; G01J 1/44; H02J 3/381; H02J 3/004; G06T 2207/10016; G06T 2207/30192; G06T 2207/20084; G06T 2207/10024; G06K 9/4661

(57) ABSTRACT

A method of predicting the intensity of sun light irradiating the ground. At least two input images are provided of a time series of images captured from the sky; a plurality of image features are extracted from the at least two input images; a set of meta data associated with the at least two input images are determined; the image features and the meta data are supplied as input data to a neural network; and neural network operations predict the future intensity of the sun light as a function of the input data. Further, a data processing unit and a computer program for controlling or carrying out the described method are described, as well as an electric power system with such a data processing unit.

### FIELD OF INVENTION

The present invention generally relates to the technical field of photovoltaic power generation, wherein cloud dynamics within a local area of a photovoltaic power plant are predicted. In particular, the present invention relates to a method for predicting the intensity of sun light irradiating onto ground. Further, the present invention relates to a data processing unit and to a computer program for carrying and/or controlling the method. Furthermore, the present invention relates to an electric power system with such a data processing unit.

### ART BACKGROUND

In many geographic regions photovoltaic power plants are an important energy source for supplying renewal energy or power into a power network or utility grid. By nature, the power production of a photovoltaic power plant depends on the time varying intensity of sun light which is captured by the photovoltaic cells of the photovoltaic power plant.

By far the most important factor that determines not only the power production but also the efficiency and the stability of a photovoltaic power plant is the cloud coverage of the sun light. A cloud coverage variation typically results in an unstable irradiation which may result (in extreme cases) in a blackout or an energy loss within a power network being fed with electric power from a photovoltaic power plant.

Unfortunately, cloud dynamics within a local area of a photovoltaic power plant and within a short time horizon such as e.g. about 20 minutes cannot be accurately predicted by known computational models.

Generally, a camera based system installed in the vicinity of a photovoltaic power plant can be used for a cloud coverage prediction. Such a system captures images of the sky continuously over periodic intervals, for example, every few seconds. By means of an analysis of a time series of captured images a reasonable estimate of cloud trajectories may be obtained.

Unfortunately, an estimate of the cloud coverage made by a human being can only be a qualitative one. Specifically, for a human being it is virtually impossible to quantitatively predict the sun light irradiation, a quantity which is directly indicative for the amount of electric power which can be generated by a photovoltaic power plant. However, the irradiation is a quantity which a Hybrid Power Optimizer (HPO) needs to know for controlling different types of electric power generation plants in order to stabilize a power network which is receiving electric power from the various electric power generation plants.

A quantitative estimate with regard to the time and with regard to the extent a cloud coverage will occur in the near future requires a sophisticated computational analysis. Such an analysis may employ a so called cloud segmentation allowing to identify pixels of the captured images as to be a “cloud pixel”. A conventional image processing algorithm which performs such a cloud segmentation on a sequence of images may provide a cloud coverage forecast. However, there is no reliable correlation between such a cloud coverage forecast and a quantitative sun light irradiation prediction. This is because the irradiation varies largely with the time of the day, the day of the year, etc. and also, to a smaller extent, with many other subtle astronomical conditions.

There may be a need for improving the reliability of a quantitative prediction for the intensity of a sun light irradiation.

### SUMMARY OF THE INVENTION

This need may be met by the subject matter according to the independent claims. Advantageous embodiments of the present invention are described by the dependent claims.

According to a first aspect of the invention there is provided a method for predicting the intensity of sun light irradiating onto ground in the (near) future. This sun light intensity can be captured by a photovoltaic power plant in order to produce electric energy. The provided method comprises (a) providing at least two input images of a time series of images captured from the sky; (b) extracting a plurality of image features from the at least two input images; (c) determining a set of meta data associated with the each input images; (d) supplying the image features and the meta data as input data to a neural network; and (e) predicting, by means of neural network operations, the future intensity of the sun light as a function of the input data.

The described method is based on the idea that with a so called deep learning approach, which is realized by means of a neural network, the problem of a quantitative irradiation prediction can be addressed when not only relying on pure image data or image features extracted from image data by means of known image processing procedures but also when taking into account meta data as an (additional) input for neural network data processing. The prediction time horizon may be the “near future”, i.e. a time window of 0 minutes to 60 minute, in particular 0 minutes to 30 minutes and more particular 5 minutes to 20 minutes.

In some embodiments the employed neural network comprises at least one Recurrent Neural Network (RNN) module such as a Long Short-Term Memory (LSTM). In this case the entire employed neural network may be denominated a RNN and/or at least some of the neural network operations may be denominated recurrent neural network operations.

Descriptively speaking, with the “proven power” of so called “deep learning” a RNN architecture is used to perform regressions as a solar irradiance predictor. Within the RNN, a so called gated recurrent unit (RGU) or long short-term memory (LSTM) may be employed for a feature sequence analysis. An GRU/LSTM itself is a typical and known key structure of a RNN. With a GRU/LSTM, the RNN amounts to infinite layer capacity. It can “memorize” past information and, together with new input, make a classification or prediction that takes into account the intrinsic dynamics of the data. Better yet, it only requires a relatively small amount of data for training, as compared to other deep learning structures that must be equipped with hundreds of million parameters. With the described method a strong prior knowledge, loose features, and data driven learning is combined for feature representation and regression into a seamless framework.

In this document the term “intensity of sun light irradiating onto ground” may particularly denote the so called “solar irradiance” which may be defined as the sun power per unit area (i.e. the intensity respectively the energy per time unit and per unit area) in form of electromagnetic radiation within a wavelength range which is covered by the respective solar irradiance measurement device.

In this document the term “image features” may particularly denote any (time varying) image information which might be indicative for a change of the sun light intensity when the corresponding sun light propagates through the atmosphere. Specifically, the image features may be indicative for a (time varying) estimation of sun light absorption and/or sun light scattering caused in particular by clouds which can be identified in the input images e.g. by means of known cloud segmentation procedures. Specifically, by comparing the at least two input images with each other one can identify a cloud movement within the time window between capturing the at least two input images and one can estimate, based on the identified cloud movement, the cloud movement within the “near future”.

It is pointed out that the prediction accuracy of the described method may typically depend on the number of input images being comprised in time series of images and being used. Presently, a good compromise between computing power being required for carrying out the described method and the prediction accuracy may be the use of a time series of e.g. 8 or 16 input images.

In this document the term “meta data” may particularly denote any information which is associated with (the capturing of) the at least two input images but which is not or at least not directly included in the images. The “meta data” may be in particular so called descriptive metadata, which are indicative for conditions which were given at the time of capturing an image sequence consisting or comprising the at least two input images and/or which are indicative for general properties of the captured input images such as e.g. color, resolution, exposure time etc.

In this document the term “neural network” and/or the term “recurrent neural network” may particularly denote a class of an artificial neural network where connections between nodes form a directed graph with feedback links along a sequence. This may allow to exhibit and also to predict a dynamic temporal behavior for or within a certain future time window. Unlike a feedforward neural network, a RNN can use its internal state stored in a memory to process sequences of inputs. In accordance with an embodiment of the invention such a RNN is used for a (near) future estimation of the sun light intensity.

According to an embodiment of the invention the method further comprises (a) performing a first cloud segmentation of a first input image and a second cloud segmentation of the second input image; (b) calculating cloud velocities for cloud portions identified by means of the first cloud segmentation and the second cloud segmentation; and (c) prescribing a spatial irradiation prediction zone within each one of the at least two input images based on the calculated cloud velocities and a predetermined position of the sun within the input images. In the following, image features are extracted solely from the prescribed spatial irradiation prediction zone.

The use of the spatial irradiation prediction zone may provide the advantage that the RNN will only perform neural network calculations for respectively a selected portion of the at least two input images, wherein the selected portion corresponds to a certain region of interest which may become relevant for the sun light irradiation prediction. In this way computational power can be reduced without lowering the reliability of the irradiation prediction.

Specifically, the spatial irradiation prediction zone is a region of interest which may become relevant for a cloud coverage of sun light which, in the absence of clouds, would reach a photovoltaic power plant without an attenuation caused by clouds. Thereby, it is clear that the size, the shape and the position of the prediction zone depends in particular on the current position of the sun and the cloud velocities. For practical reasons the shape of the prediction zone may be at least approximately a rectangle.

The position of the sun only depends on the geographic location (of the photovoltaic power plant) and on the time of the day and the time of the year. Therefore, the current position of the sun is an exactly predetermined quantity. The cloud velocities can be calculated on the basis of a distance a cloud portion has travelled within a time period between capturing the first input image and capturing the second input image. Thereby, known procedures of image processing and cloud segmentation may be employed.

The cloud velocities may be calculated on the basis of an “optical flow” of the respective cloud portions. Thereby, with a sequence of sky images where the position of the sun is known first the optical flow of the cloud velocities is computed. Assuming that all image structures which can be seen in the at least two images are two-dimensional and when looking from the center of the sun, the orientation of the cloud movement allows to prescribe an area of interest within a restricted zone, which in this document is referred to as the spatial irradiation prediction zone. This prediction zone is where the clouds, if any, will possibly move in to cover the sun.

It is (again) pointed out that in principle two input images are enough in order to calculate the cloud velocities. However, the cloud velocity determination may be more accurate when relying not only on two but on more than two input images of the time series of input images.

Further, it is mentioned that although taking into account the calculated cloud velocities may be preferable for defining (or prescribing) a proper spatial irradiation prediction zone in some embodiments such a prediction zone may be defined without the calculated cloud velocities. For instance, one could construct concentric rings of different radii around the position of the sun and compute, for each ring, an image feature statistic. The entirety of such image feature statistics (obtained from at least some of the rings) may be used as the extracted plurality of image features as described above. This means that in such embodiments the spatial irradiation prediction zone has the shape of a circle.

According to a further embodiment of the invention extracting the plurality of image features comprises (a) subdividing the spatial irradiation prediction zone into a plurality of parallel pixel stripes which are oriented at least approximately perpendicular to the direction of a general cloud velocity; (b) determining, for each pixel stripe of the plurality of pixel stripes, several characteristic pixel intensity values; and (c) using the determined characteristic pixel intensity values as the image features supplied to the neural network.

The described pixel stripe subdivision of the (spatial irradiation) prediction zone may provide the advantage that the amount of data, which must be handled and processed by the RNN, can be significantly reduced. As a consequence, with a given computational power the described method can be carried out with a high frequency or repetition rate such that a sun light irradiation prediction can be made in a quasi-continuous manner.

By orienting the subdivided pixel stripes at least approximately perpendicular to the general cloud velocity the described method may be made very sensitive to the movement of cloud(s) in the sky. Hence, even with a limited computational power very reliable irradiation predictions results can be provided.

The general cloud velocity may be an average taken from all calculated cloud velocities. Thereby, the average may be an arithmetic average or a weighted average wherein e.g. cloud portions which are located closer to the sun and/or cloud portions with an expected trajectory being comparatively close to the sun, are taken into account with a higher weighing factor than other cloud portions.

Given a certain width for the pixel stripes the typical number of pixel stripes, which are used for subdividing the (entire) prediction zone, may be 20 to 2000, preferably 40 to 1000, and more preferably 80 to 500. The inventors have obtained good irradiation prediction results with a total number of 200 pixel stripes. However, in this context it should be clear that the total number of pixel stripes may particularly depend on the available computational power and/or on the size of the spatial irradiation prediction zone.

According to a further embodiment of the invention each pixel stripe has a width of one pixel. This means that the spatial resolution with which the described method is carried out, is maximal for the direction parallel to or along with the general cloud velocity. This makes the irradiation predictions results very reliable.

According to a further embodiment of the invention the several characteristic pixel intensity values include, for each pixel row, at least one of (a) a mean intensity value of all individual pixel values of the pixels being assigned to the respective pixel row; (b) a maximum intensity value being the highest intensity value of all pixels of the pixel row; and (c) a minimum intensity value being the lowest intensity value of all pixels of the pixel row. This may provide the advantage that with a simple logical and/or mathematical rule the number of data which has to be processed will be reduced significantly while still keeping most information being relevant for a precise and reliable irradiation prediction. Preferably, all the mentioned intensity values are taken into account for predicting the sun light intensity.

According to a further embodiment of the invention each one of the input images is a color image captured within a color space having at least a first color, a second color, and a third color. Further, the several characteristic pixel intensity values include first characteristic pixel intensity values being assigned to the first color, second characteristic pixel intensity values being assigned to the second color, and third characteristic pixel intensity values being assigned to the third color. This may provide the advantage that also color information will be taken into account. As a consequence, the reliability and/or the validity of the irradiation predictions results will be further improved.

According to a further embodiment of the invention the meta data include at least one of the following information: (a) sun light intensity measured at the time of capturing at least one of the at least two input images; (b) several sun light intensities measured (in the past) within a predefined time window, and (c) average sun light intensity measured within a predefined time interval at the time of capturing at least one of the at least two input images. Using the information about the sun light intensity (at the time when capturing the at least two input images) may provide the advantage that the “learning efficiency” of the RNN will be increased because benefit can be taken from input data which in the “real physical world” represent the same physical quantity as the quantity which is predicted with the described method. Depending on the specific application, i.e. typical weather condition changes which may depend on the respective geographic location and/or on the time of the day/year the duration of the predefined time interval may set appropriately.

According to a further embodiment of the invention the sun light intensity is measured at ground, in particular by means (of known procedures) of pyranometry and/or a (known) pyranometer apparatus. This may provide the advantage that the sun light intensity being used as meta data can be measured (experimentally) exactly at the location for which the sun light irradiation intensity is to be predicted. In case of a photovoltaic power generation the “ground”, at which the sun light intensity is measured, is the location of the photovoltaic cells of the respective photovoltaic power plant.

According to a further embodiment of the invention the meta data (further) include at least one of the following information: (a) time of the day when capturing at least one of the at least two input images; (b) day of the year when capturing at least one of the at least two input images; and (c) geographic location of the ground.

Using the described meta data as an (additional) input for the RNN may provide the advantage that they can be easily provided and/or determined because they do not depend on special external operational conditions such as e.g. weather/climate and/or internal operational conditions which may be indicative for the current operational state of the respective photovoltaic power plant. Thereby, the internal operational state may depend e.g. on the actual electric power production, maintenance intervals, number of solar panels being actually used, etc. Although the described meta data information is (at first glance) a physical very simple information it may provide an important contribution towards a reliable solar irradiance prediction and in particular to a high “self-learning efficiency” of the employed RNN.

In this respect it is mentioned that all the above described information which is used for the embodiment described here is related to the angle of solar irradiation which by nature is a very important factor for (predicting) the solar irradiance.

According to a further embodiment of the invention the neural network comprises (a) an input layer receiving the image features and the meta data; (b) a Long Short-Term Memory (LSTM) layer processing the received image features and meta data and outputting a data set; and (c) at least one further neural network layer receiving the processed image features and meta data as a neural data set and further processing the neural data set. The predicted future intensity of the sun light depends on the further processed neural data set.

As has already been mentioned above, a LSTM being comprised in the LSTM layer is a known key structure of a RNN. Due to its capability of memorizing a LSTM virtually increases the number of layers of a RNN to infinite. A LSTM can be seen as a structure comprising at least an input gate, a neuron with a self-recurrent connection, a forget gate, and an output gate.

The at least one further neural network layer may be a so called dense layer, which in accordance with known basis principles of neural networks is used to change the dimensionality of a (vector) data set. Mathematically speaking, the at least one dense layer applies a rotation, a scaling, and/or a translation transformation to a (vector) data set in order to reduce its dimensionality. When using more than one further neural network (dense) layer there may be realized a multiple inputs structure at different layers of the RNN in order to accommodate different length/dimensionality of output sequences respectively data sets.

According to a further embodiment of the invention the neural network further comprises (a) a further input layer receiving at least one weighing factor and outputting a corresponding weighing data set; and (b) a weighing layer receiving the further processed neural data set and the output weighing data set. In this embodiment the predicted future intensity of the sun light further depends on the weighing data set.

With the described weighing layer performing a weighing of the processed data the impact or the weight of some selected data can be reduced and/or the impact or the weight of some other selected data can be increased. Thereby, operating conditions which have a predefined or known influence on the data processing can be taken into account in order to end up with further improved prediction results. For instance, if the calculated wind speeds respectively cloud velocities are very high there is at least a certain probability that the calculated values are not correct. By reducing the weights for the corresponding data, if applicable to a weight of zero, wrong prediction results may be avoided. In other words, the described weighing layer can be used for adding plausibility data to the data processing which may significantly reduce the chance for (completely) wrong solar irradiation prediction results.

According to a further embodiment of the invention providing the at least two input images comprises (a) capturing at least two images from the sky by employing a wide-angle lens; and (b) transforming respectively one of the captured images to one of the at least two input images by applying an unwarping image processing operation. This may provide the advantage that an optical adjustment of a camera system repeatedly capturing the images from the sky need not to be changed during the day when the “position of the sun” changes (due to the rotation of the earth). The same holds true for different times of the year (in locations different from the equator due to the inclination of the rotational axis of the earth).

The described wide-angle lens may be (preferably) a so called fish-eye lens which may allow for representing the whole sky with one and the same captured image. Of course, the larger the angle of the wide-angle lens is, the more important is an accurate unwarping in order to arrive at input images which can be further processed in a reliable manner.

According to a further aspect of the invention there is provided a data processing unit for predicting the intensity of sun light irradiating onto ground. The provided data processing unit is adapted for carrying out the method as described above.

According to a further aspect of the invention there is provided a computer program for predicting the intensity of sun light irradiating onto ground. The computer program, when being executed by a data processing unit, is adapted for carrying out the method as described above.

As used herein, reference to a computer program is intended to be equivalent to a reference to a program element and/or to a computer readable medium containing instructions for controlling a computer system to coordinate the performance of the above described method.

The computer program may be implemented as a computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The invention may be realized by means of a computer program respectively software. However, the invention may also be realized by means of one or more specific electronic circuits respectively hardware. Furthermore, the invention may also be realized in a hybrid form, i.e. in a combination of software modules and hardware modules.

The invention described in this document may also be realized in connection with a “CLOUD” network which provides the necessary virtual memory spaces and the necessary virtual computational power.

According to a further aspect of the invention there is provided an electric power system comprising (a) a power network; (b) a photovoltaic power plant for supplying electric power to the power network; (c) at least one further power plant for supplying electric power to the power network and/or at least one electric consumer for receiving electric power from the power network; (d) a control device for controlling an electric power flow between the at least one further power plant and the power network and/or between the power network and the at least one electric consumer; and (e) a prediction device for producing a prediction signal being indicative for the intensity of sun light being captured by the photovoltaic power plant in the future. The prediction device comprises a data processing unit as described above. Further, the prediction device is communicatively connected to the control device, and the control device is configured to control, based on the prediction signal, the electric power flow in the future.

The described electric power system is based on the idea that with a valid and precise prediction of the intensity of sun radiation, which can be captured by the photovoltaic power plant in the (near) future, the power, which can be supplied from the photovoltaic power plant to the power network, can be predicted in a precise and reliable manner. This allows to control the operation of the at least one further power plant and/or of the at least one electric consumer in such a manner that the power flow(s) to and the power flow(s) from the power network are balanced at least approximately. Hence, the stability of the power network and, as a consequence, also the stability of the entire electric power system can be increased.

The prediction device may comprise a camera for capturing a time series of images including the first input image and the second image. The time series of images will be forwarded to the data processor for processing the corresponding image data in the manner as described above.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this document.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWING

FIG. 1 shows an image taken from the sky above a photovoltaic power plant, wherein in a region close to the sun there is indicated a spatial irradiation prediction zone.

FIG. 2 illustrates a subdivision of the spatial irradiation prediction zone into a plurality of pixel stripes being oriented perpendicular to the general cloud velocity.

FIG. 3 shows the architecture of a neural network for predicting the intensity of sun light irradiating onto ground.

FIG. 4 shows an electric power system with a data processing unit in accordance with an embodiment of the invention.

### DETAILED DESCRIPTION

The illustration in the drawing is schematic. It is noted that in different figures, similar or identical elements or features are provided with the same reference signs or with reference signs, which are different from the corresponding reference signs only within the first digit. In order to avoid unnecessary repetitions elements or features which have already been elucidated with respect to a previously described embodiment are not elucidated again at a later position of the description.

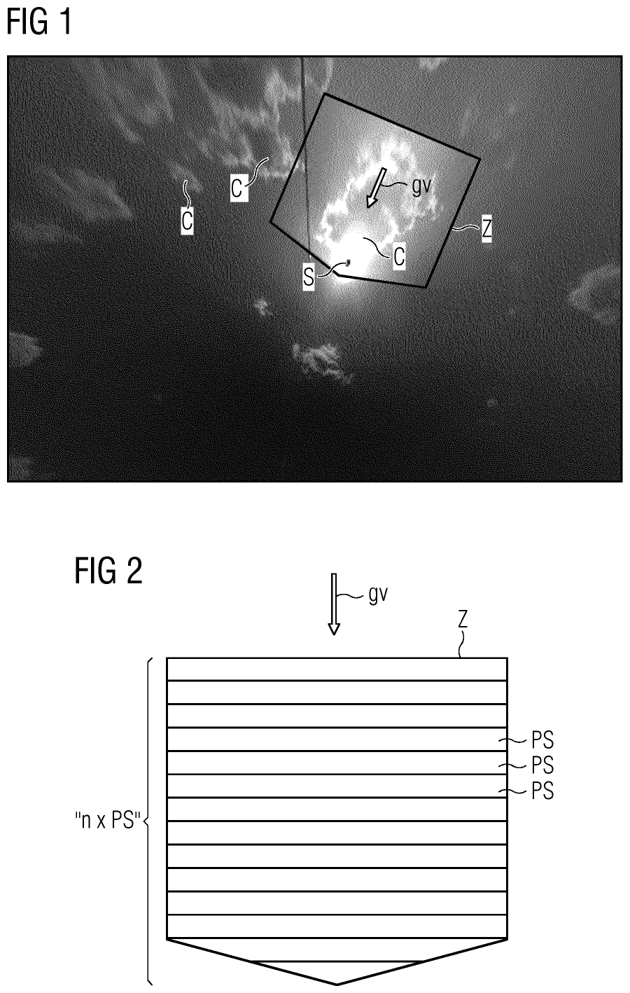

FIG. 1 shows an image I taken from the sky above a non-depicted photovoltaic power plant. The image I may be used as one of the at least two captured input images for performing the method for predicting the intensity of sun light irradiating onto ground, which method is described with different embodiments in this document.

In FIG. 1 the sun, which can be seen as the brightest region, is denominated with a reference numeral S. Clouds, some of which are denominated with a reference numeral C, can also be seen in FIG. 1. Illustrated with a rectangular is a spatial irradiation prediction zone Z. As has already been described above, this prediction zone Z is a region of interest within the image I, which region may become relevant for a cloud coverage of sun light which, in the absence of clouds, would reach a photovoltaic power plant without at least a cloud attenuation. According to the exemplary embodiment described here the size and the position of the prediction zone Z is determined or prescribed by the following procedure:

(A) A cloud segmentation is performed within at least two (different) input images yielding two spatial cloud distributions.

(B) The spatial difference between the two spatial cloud distributions is determined.

(C) Based on the spatial difference and a time difference between capturing the two input images a general cloud velocity gv is determined.

(D) Based on the general cloud velocity gv at least the length of the spatial irradiation prediction zone Z along the direction of the general cloud velocity gv is determined. The width of the prediction zone Z (perpendicular to the direction of the general cloud velocity gv) can be selected based on a-priori knowledge for possible wind direction changes, which may be characteristic for the geographic position within which the intensity of sun light is to be predicted.

According to the exemplary embodiment described here, for carrying out the method for predicting the intensity of sun light irradiating onto ground, only image features are used which are located within the spatial irradiation prediction zone Z.

In the following a preferred embodiment of a method for predicting the intensity of sun light irradiating onto ground in accordance with various embodiments of the invention is described in detail. In this preferred method there is combined (a) a strong a-priori knowledge, (b) “loose” image features extracted from at least two input images, (c) “loose” meta data associated with the at least two input images, and (d) a data driven learning for feature representation and regression into a seamless framework. Most of the method steps are carried out by means of a recurrent neural network (RNN).

Descriptively speaking, given a sequence of sky images wherein the position of the sun S is known e.g. by means of a calibration step, there is first computed the optical flow of the (general) cloud velocity gv. Processing in 2 dimensions and looking from the position of (the center of) the sun, the cloud motion orientation allows to prescribe an area of interest within a restricted zone, referred in this document as the spatial irradiation prediction zone Z.

FIG. 2 illustrates a subdivision of the spatial irradiation prediction zone Z into a plurality of pixel stripes PS being oriented perpendicular to the general cloud velocity gv. Specifically, according to the exemplary embodiment described here, within the prediction zone Z there are defined one-pixel wide stripes PS which together fill up the prediction zone Z. The number of the pixel stripes PS is “n”. Within each pixel stripe PS there is a plurality of non-depicted pixels. According to the exemplary embodiment described here, due to the angulate shape of the prediction zone Z, some pixel stripes PS being close to the sun are shorter than other pixel stripes PS being located farer away from the sun. This means that in this case the number of pixels of each pixel stripe PS is not the same for all pixel stripes PS. A typical number of pixels within one pixel stripe PS may be 40.

For the following description it is assumed that the number n of pixels stripes PS is equal to 200. Further, it is assumed that each pixel comprises three sub-pixels each being assigned to one color of a color space. In the image I under consideration each sub-pixel (of each pixel) has a certain intensity value. The colors may be e.g. red (R), green (G), and blue (B).

In order to deal with a limited amount image features (of the prediction zone Z) in the embodiment described here the following procedure is carried out (for keeping the amount of data to be handled within acceptable limits): Within each pixel stripe PS and for each color R, G, B there is determined (a) the biggest intensity value I_max, (b) the smallest intensity value I_min, and (c) the mean intensity value I_mean. This means that for each pixel stripe PS there are determined 3×3=9 image features. This means that from the entire prediction zone Z there are determined 200×9=1800 image features. These 1800 image feature correspond to an N-tuple feature vector (here and so far N is equal to 1800) consisting of simple statistics from each pixel stripe PS.

This feature vector is then supplemented or concatenated with meta data. According to the exemplary embodiment described here the following meta data are used:

(1) The past solar irradiance, here denominated precisely the intensity of sun light, which has been measured before at different points in time within a certain time window: In the following it is assumed that this time window is 1 minute and the time interval between two subsequent images is 5 seconds. Together with the current irradiance measurement this amounts to 13 meta data values.

(2) The hour and the minute of the day: These are two further meta data values.

(3) The (general) cloud velocity: This is one further meta data value.

This means that according to the exemplary embodiment described here a 1816-tuple vector is processed respectively is used as an input for an RNN in order to predict the intensity of sun light which will irradiate at ground within the (near) future within a time horizon of e.g. 20 minutes. The characteristic features can be trained in the RNN in order to match the measured irradiance (i.e., the ground truth as the supervision). All training may be prepared from images and pyranometry values acquired in the past several years, so there will be enough data to train the RNN.

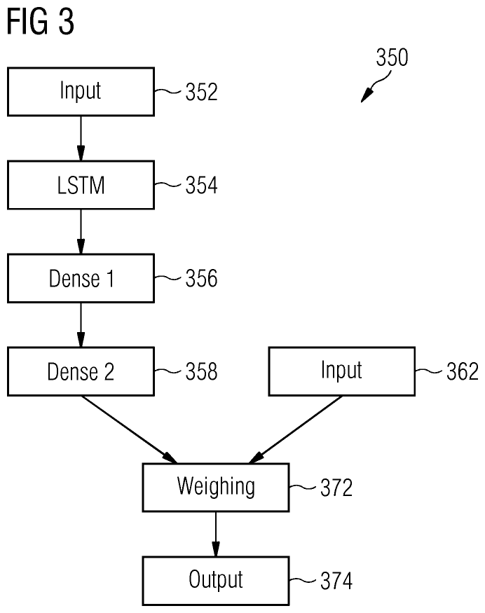

FIG. 3 shows an exemplary architecture of a preferred neural network design 350 for predicting the intensity of sun light irradiating onto ground.

A first layer 352 is an input layer with which the above described N-tuple vector (N=1816) is received. A next layer of the network 350 is a Long Short-Term Memory (LSTM) layer 354, wherein most of the data processing of the described method is carried out. As has already been mentioned above, a LSTM is a known key RNN structure. Due to its capability of memorizing a LSTM virtually increases the number of layers to infinite relative to a feedforward neural network.

After the LSTM layer 354 there are provided, just as an example, two further neural network layers 356 and 358. These layers are used for reducing respectively consolidating the number N (here N is a hyper parameter of the LSTM) of the LSTM processed N-tuple vector. In other words, the N dimensionality of the vector is reduced to N−dN, wherein dN corresponds to the amount of this (data) reduction.

As can be seen from FIG. 3, the network 350 further comprises a further input layer 362. According to the exemplary embodiment described here predefined weighing factors are input. Preferably, for each value respectively dimension of the N-tuple vector one weighing factor is employed.

Within a weighing layer 372 of the depicted exemplary network 350 a weighing operation is carried out. As has already been mentioned above, in this weighing layer 372 the impact or the weight of some selected values of the processed vector (having a reduced dimensionality) can be reduced and/or the impact or the weight of some other selected values can be increased.

With an output layer 374 of the network 350 the result, namely the predicted intensity of sun light irradiating onto ground, is output. Thereby, predicted sun light intensity values for several points in time within a predetermined future time horizon can be provided.

The predicted sun light intensity values are indicative for the power generation of a photovoltaic power plant which is expected within the future. This information can be used for controlling the operation of a power system, wherein apart from the photovoltaic power plant at least one further different type electric power plant feeds electric power to a power network. Further details are given in the following.

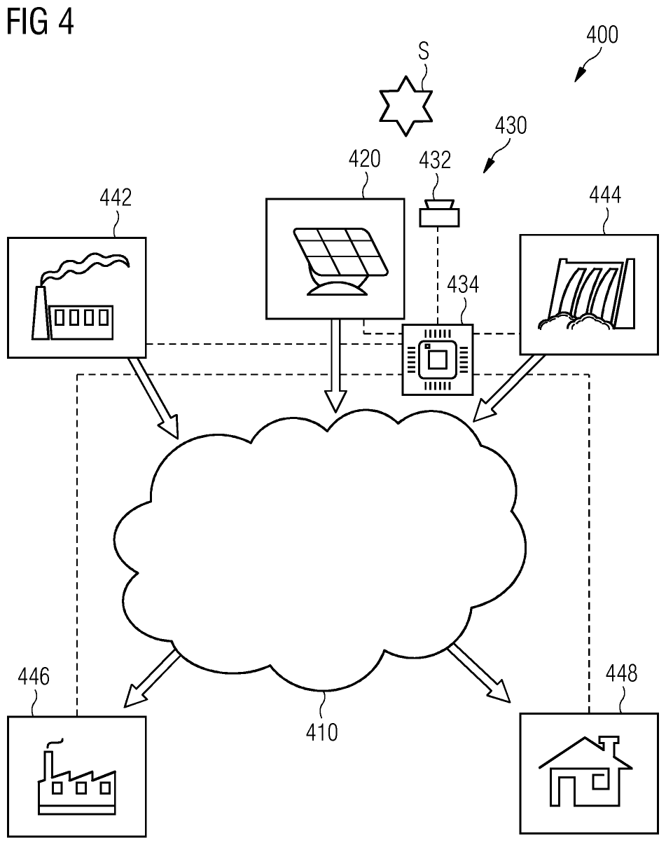

FIG. 4 shows an electric power system 400 in accordance with an embodiment of the invention. The electric power system 400 comprises a power network 410 which receives electric power from three exemplary depicted power plants, a photovoltaic power plant 420, a coal-fired power plant 442, and a hydroelectric power plant 444. It is pointed out that the power plants 442 and 444 are just given as an example and other and/or different numbers of such plants can be used. Further, the electric power system 400 comprises two electric power consumers receiving electric power from the power network 410. In FIG. 4 there are depicted, by way of example, an industrial complex 446 and a household 448. The power flows from the power plants 420, 442, and 444 to the power network 410 as well as the power flows from the power network 410 to the electric consumers 446 and 448 are indicated in FIG. 4 with double arrows.

The photovoltaic power plant 420 is driven by the sun S irradiating on non-depicted solar panels of the photovoltaic power plant 420. In order to predict the electric power, which can be generated by the photovoltaic power plant 420 in the near future, there is provided a prediction device 430. The prediction device 430 comprises a camera 432 for capturing a series of images of the sky over the photovoltaic power plant 420. The captured images, two of which are the input images I1 and I2 as described above, are forwarded to a data processing and control device 434. A data processing section or data processing unit of the data processing and control device 434 is configured for carrying out the method as described above for classifying pixels within the captured images whether they represent cloud or sky. A control section of the data processing and control device 434 is communicatively connected with (at least some of) the power plants 442 and 644 and with (at least some of) the electric consumers 446 and 448. The corresponding wired or wireless data connections are indicated in FIG. 4 with dashed lines.

With (the data processing unit of) the data processing and control device 434 carrying out the described method a prediction of the expected solar irradiance within the near future can be made. This irradiance prediction directly corresponds to a prediction of the power, which can be supplied from the photovoltaic power plant 420 to the power network 410 in the near future. This allows to control, by means of (the control section of) the data processing and control device 434, the operation of the power plants 442, 444 and/or the electric consumers 446, 448 can be controlled in such a manner that the power flow to and the power flow from the power network 410 are balanced at least approximately. Hence, the stability of the power network 410 and, as a consequence, also the stability of the entire electric power system 400 can be increased.

It is pointed out that in the embodiment described here the data processing unit and the control section are realized by one and the same device, namely the data processing and control device 434. However, it should be clear that the data processing unit and the control section can also be realized by different devices which are communicatively connected in order to forward the prediction signal from the data processing unit to the control section.

It should be noted that the term “comprising” does not exclude other elements or steps and the use of articles “a” or “an” does not exclude a plurality. Also elements described in association with different embodiments may be combined. It should also be noted that reference signs in the claims should not be construed as limiting the scope of the claims.

### LIST OF REFERENCE SIGNS

I input image
S sun
C clouds
Z spatial irradiation prediction zone
gv general cloud velocity
PS pixel stripe
n Number of pixel stripes
350 network architecture
352 input layer
354 LSTM layer
356 first dense layer
358 second dense layer
362 further input layer
372 weighing layer
374 output layer
400 electric power system
410 power network
420 photovoltaic power plant
430 prediction device
432 camera
434 data processing and control device
442 coal-fired power plant/gas-fired power plant
444 hydroelectric power plant
446 industrial complex/factory
448 household(s)/domestic home (s)

1-15. (canceled)

16. A method for predicting the intensity of sun light irradiating onto ground, the method comprising
providing at least two input images of a time series of images captured from the sky;
extracting a plurality of image features from the at least two input images;
determining a set of meta data associated with the at least two input images;
supplying the image features and the meta data as input data to a neural network; and
predicting, by way of neural network operations, a future intensity of the sun light as a function of the input data.

17. The method according to claim 16, further comprising
performing a first cloud segmentation of a first input image and a second cloud segmentation of a second input image;
calculating cloud velocities for cloud portions identified by way of the first cloud segmentation and the second cloud segmentation; and
prescribing a spatial irradiation prediction zone within each one of the at least two input images based on the calculated cloud velocities and a predetermined position of the sun within the input images; and
thereby extracting image features solely from the prescribed spatial irradiation prediction zone.

18. The method according to claim 16, wherein the step of extracting the plurality of image features comprises
subdividing the spatial irradiation prediction zone into a plurality of parallel pixel stripes which are oriented at least approximately perpendicular to a direction of a general cloud velocity;
determining, for each pixel stripe of the plurality of pixel stripes, several characteristic pixel intensity values; and
using the characteristic pixel intensity values obtained in the determining step as the image features supplied to the neural network.

19. The method according to claim 18, wherein each pixel stripe has a width of one pixel.

20. The method according to claim 18, wherein
the several characteristic pixel intensity values include, for each of the pixel stripes, at least one of
a mean intensity value of all individual pixel values of pixels assigned to the respective pixel stripe;
a maximum intensity value being a highest intensity value of all pixels of the pixel stripe; or
a minimum intensity value being a lowest intensity value of all pixels of the pixel stripe.

21. The method according to claim 18, wherein:
each one of the input images is a color image captured within a color space having at least a first color, a second color, and a third color; and
the several characteristic pixel intensity values include first characteristic pixel intensity values assigned to the first color, second characteristic pixel intensity values assigned to the second color, and third characteristic pixel intensity values assigned to the third color.

22. The method according to claim 16, wherein the meta data include at least one of the following information:
sun light intensity measured at a time of capturing at least one of the at least two input images;
several sun light intensities measured within a predefined time window, and
average sun light intensity measured within a predefined time interval at the time of capturing at least one of the at least two input images.

23. The method according to claim 16, which comprises measuring the sun light intensity on the ground.

24. The method according to claim 23, which comprises measuring the sun light intensity by way of pyranometry and/or with a pyranometer apparatus.

25. The method according to claim 16, wherein the meta data include at least one of the following information:
a time of the day when the at least one of the at least two input images is captured;
a day of the year when at least one of the at least two input images is captured; and
a geographic location of the ground.

26. The method according to claim 16, wherein the neural network comprises
an input layer receiving the image features and the meta data;
a Long Short-Term Memory layer processing the received image features and meta data and outputting a data set; and
at least one further neural network layer receiving the processed image features and meta data as a neural data set and further processing the neural data set; wherein the predicted future intensity of the sun light depends on the further processed neural data set.

27. The method according to claim 26, wherein the neural network further comprises:
a further input layer receiving at least one weighting factor and outputting a corresponding weighting data set; and
a weighting layer receiving the further processed neural data set and the output weighting data set,
wherein the predicted future intensity of the sun light further depends on the weighing data set.

28. The method according to claim 16, wherein the step of providing the at least two input images comprises capturing at least two images from the sky by employing a wide-angle lens; and transforming respectively one of the captured images to one of the at least two input images by applying an unwarping image processing operation.

29. A data processing unit for predicting an intensity of sun light irradiating onto ground, wherein the data processing unit is configured for carrying out the method according to claim 16.

30. A non-transitory computer program for predicting an intensity of sun light irradiating onto ground, the computer program, when being executed by a data processing unit, being configured for carrying out the method according to claim 16.

31. An electric power system, comprising:
a power network;
a photovoltaic power plant for supplying electric power to the power network;
at least one further power plant for supplying electric power to the power network and/or at least one electric consumer for receiving electric power from the power network;
a control device for controlling an electric power flow between the at least one further power plant and the power network and/or between the power network and the at least one electric consumer; and
a prediction device for producing a prediction signal that is indicative of an predicted intensity of sun light being captured by the photovoltaic power plant in the future; wherein
said prediction device includes a data processing unit for predicting an intensity of sun light irradiating onto ground, and the data processing unit is configured for carrying out the method according to claim 16;
said prediction device is communicatively connected to said control device, and
said control device is configured to control the electric power flow in the future based on the prediction signal.
